(19) United States
(12) Patent Application Publication
(10) Pub. No.: US 2022/0353614 A1
(43) Pub. Date: Nov. 3, 2022

(54) LOUDSPEAKER SYSTEM LAYOUT FOR GENERATING LOW FREQUENCY AUDIO OUTPUTS IN INDIVIDUAL SOUND ZONES

(71) Applicant: Harman Becker Automotive Systems GmbH, Karlsbad (DE)

(72) Inventors: Tingli CAI, Ann Arbor, MI (US); Markus E. CHRISTOPH, Straubing, Bayern (DE)

(73) Assignee: Harman Becker Automotive Systems GmbH, Karlsbad (DE)

(21) Appl. No.: 17/771,347

(22) PCT Filed: Oct. 25, 2019
(86) PCT No.: PCT/US2019/057988

§ 371 Date: Apr. 22, 2022

(51) Int. Cl. H04R 5/02; G10K 11/178; B60N 2/879

(52) U.S. Cl. CPC H04R 5/02; G10K 11/178; B60N 2/879; H04R 2499/13; G10K 2210/12821

(57) ABSTRACT

In at least one embodiment, a loudspeaker arrangement for a vehicle is provided. The loudspeaker arrangement includes a surround sound loudspeaker arrangement and at least one proximity woofer. The surround sound loudspeaker arrangement includes a plurality of surround woofers being positioned in a listening environment in the vehicle that defines a plurality of sounds zones to provide a first low frequency audio output having a first sound pressure level within the vehicle. The at least one proximity woofer is positioned about a first seat in a first sound zone of the vehicle, the at least one proximity woofer being configured to provide a second low frequency audio output in the first sound zone of the vehicle. The second low frequency audio output as provided by the at least one proximity woofer modifies the first sound pressure level to provide a target sound pressure level.

### TECHNICAL FIELD

Aspects disclosed herein may generally relate to a loudspeaker layout in a vehicle. Specifically, aspects disclosed herein may generally relate to a loudspeaker layout in a vehicle for generating low frequency audio outputs in individual sound zones.

### BACKGROUND

Common loudspeaker arrangements in an interior of a car and other vehicles, include a multiplicity of loudspeakers distributed throughout the interior. For example, broadband loudspeakers, midrange loudspeakers and tweeters may be disposed, in the dashboard, in the doors, on the pillars, the rear shelf, etc. to provide various audio sources at various positions within the car interior. Such loudspeaker arrangements may be configured to provide a surround sound listening environment. Woofers are also utilized as part of a surround sound system that also include midrange loudspeakers and tweeters. These woofers may be installed in doors of the vehicle, in a rear end of a vehicle cabin, and/or in a trunk of the vehicle. One loudspeaker arrangement may produce individual sound zones (ISZ) in the vehicle cabin. It is generally desirable to provide sufficient isolation between zones in the vehicle particularly in relation to the low frequency energy range while generating audio in the vehicle cabin utilizing a surround sound system.

### SUMMARY

In at least one embodiment, a loudspeaker arrangement for a vehicle is provided. The loudspeaker arrangement includes a surround sound loudspeaker arrangement and at least one proximity woofer. The surround sound loudspeaker arrangement includes a plurality of surround woofers being positioned in a listening environment in the vehicle that defines a plurality of sounds zones to provide a first low frequency audio output having a first sound pressure level within the vehicle. The at least one proximity woofer is positioned about a first seat in a first sound zone of the vehicle, the at least one proximity woofer being configured to provide a second low frequency audio output in the first sound zone of the vehicle. The second low frequency audio output as provided by the at least one proximity woofer modifies the first sound pressure level to provide a target sound pressure level. The target sound pressure level corresponds to a final effective sound pressure level of an audio signal that is received by a listener.

In at least another embodiment, a loudspeaker arrangement for a vehicle is provided. The loudspeaker arrangement includes a plurality of surround woofers and at least one proximity woofer. The plurality of surround woofers are positioned in a listening environment of the vehicle that defines a plurality of sounds zones to provide a first low frequency audio output having a first sound pressure level in the plurality of sound zones. The at least one proximity woofer is positioned about a first seat in a first sound zone of the vehicle. The at least one proximity woofer is configured to provide a second low frequency audio output in the first sound zone of the vehicle, The second low frequency audio output as provided by the at least one proximity woofer modifies the first sound pressure level to provide a target sound pressure level. The target sound pressure level corresponds to a final effective sound pressure level of an audio signal that is received by a listener.

In at least another embodiment, a loudspeaker arrangement for a vehicle is provided. The loudspeaker arrangement includes a surround sound loudspeaker arrangement and at least one proximity woofer. The surround sound loudspeaker arrangement includes a plurality of surround woofers being positioned in a listening environment in the vehicle that defines a plurality of sounds zones to provide a first low frequency audio output having a first sound pressure level within the vehicle. The at least one proximity woofer is positioned about a first seat in a first sound zone of the vehicle, the at least one proximity woofer being configured to provide a second low frequency audio output in the first sound zone of the vehicle. The second low frequency audio output as provided by the at least one proximity woofer modifies the first sound pressure level to provide a target sound pressure level. The target sound pressure level corresponds to a final effective sound pressure level of an audio signal that is received by a listener. The plurality of surround woofers and the at least one proximity woofer are used in at least one or more of an active noise cancellation system, a bass management system, an engine order cancellation (EOC)/road noise cancellation (RNC) system, an individual surround sound system, and individual sound zones (ISZ) for the vehicle.

### BRIEF DESCRIPTION THE DRAWINGS

The embodiments of the present disclosure are pointed out with particularity in the appended claims. However, other features of the various embodiments will become more apparent and will be best understood by referring to the following detailed description in conjunction with the accompany drawings in which:

FIGS. 1A-1B generally depict corresponding loudspeaker arrangements for woofers that are employed as part of a surround sound system in a vehicle in accordance to one embodiment;

FIG. 2 generally depicts a first loudspeaker arrangement in the vehicle in accordance to one embodiment;

FIG. 3 depicts a more detailed view of the first seat and the proximity woofer of of FIG. 2 in accordance to one embodiment;

FIG. 4 generally depicts a second loudspeaker arrangement in the vehicle in accordance to one embodiment;

FIG. 5 depicts a more detailed view of proximity woofers of FIG. 4 in accordance to one embodiment;

FIG. 6 generally depicts a third loudspeaker arrangement in the vehicle in accordance to one embodiment;

FIGS. 7A-7B depict a first side view and a second side view, respectively, of the proximity woofers of FIG. 6 in accordance to one embodiment;

FIG. 8 generally depicts a fourth loudspeaker arrangement in the vehicle in accordance to one embodiment;

FIGS. 9A-9B depict a first side view and a second side view, respectively, of the proximity woofers of FIG. 8 in accordance to one embodiment;

FIG. 10 generally depicts various plots of audio output performance for woofers that are utilized for the surround sound system in a vehicle;

FIG. 11 generally depicts various plots of audio output performance for only proximity woofers that are utilized in connection with the first loudspeaker arrangement in accordance to one embodiment;

FIG. 12 generally depicts various plots of audio output performance for the surround woofers that are utilized for the surround sound system and for the proximity woofers that are utilized in connection with the first loudspeaker arrangement in accordance to one embodiment; and

FIG. 13 generally depicts various plots of audio output performance for the surround woofers that are utilized for the surround system and for the proximity woofers that are utilized in connection with the third proximity woofer arrangement in accordance to one embodiment; and

FIG. 14 generally depicts a method for adjusting a sound pressure level of a low frequency output from surround woofers in accordance to one embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are riot to be interpreted as limiting, but merely as a representative basis for teaching one skilled in the art to variously employ the present invention.

It is recognized that directional terms that may be noted herein (e.g., “upper”, “lower”, “inner”, “outer”, “top”, “bottom”, etc.) simply refer to the orientation of various components as illustrated in the accompanying figures and the manner in which the proximity woofer(s) is positioned in the vehicle. Such terms are provided for context and understanding of the embodiments disclosed herein.

A loudspeaker system that generates audio in individual sound zones (ISZ) in a zoom may sufficiently deliver full-bandwidth separation in acoustic responses between different zones. In mid and high frequencies, the separation may be achieved passively by directivity control or shading. Additionally, the separation may be achieved through signal processing such as cross talk cancellation. In the low frequency range, for example, 20 Hz to 1000 Hz, the room acoustics may be deeply coupled with locations of the loudspeakers in the room (or vehicle cabin). Therefore, a layout of the loudspeakers may play a role in creating low frequency individual sound zones.

Traditionally, loudspeakers (or woofers) may be placed in surrounding areas of a room, or in the corners, to effectively excite room modes and to deliver low frequency energy to listening positions. Consider the example of a vehicle cabin, woofers may be placed in doors, in the rear end of the cabin, or in the trunk. Such a traditional woofer layout may have been acceptable for vehicle packaging requirements. However, this woofer layout has also been capable of delivering enough low frequency energy to various seat positions evenly, but not separately. In other words, the surround woofers may not be sufficient to create seat-to-seat separation.

To improve the separation between the zones in the vehicle in the low frequency audio range, additional woofers may be placed in closer proximity to listener's head in each zone. In this case, it may also be desirable to also keep the surround woofers in positions of the vehicle such as the door(s), rear end of the cabin, or in the trunk of the vehicle. In each zone, one or more proximity woofers may be placed next to a listener's head, behind the listener's head, or integrated into the headrest. Because of proximity of the woofer with respect to the listener's head, a smaller amount of energy may be needed to be transmitted from these loudspeakers to produce the energy level required for the listener in the vehicle. This aspect may ease the requirement of the woofer size, and in turn ease packaging requirements. Thus, by packaging surround woofers in either the door, rear of the vehicle, or in the trunk with proximity woofers that are positioned proximate to a listener's ears such as on a vehicle seat, such a condition yields sufficient separation between various zones (i.e., passengers) in the low frequency range of the audio output in the vehicle.

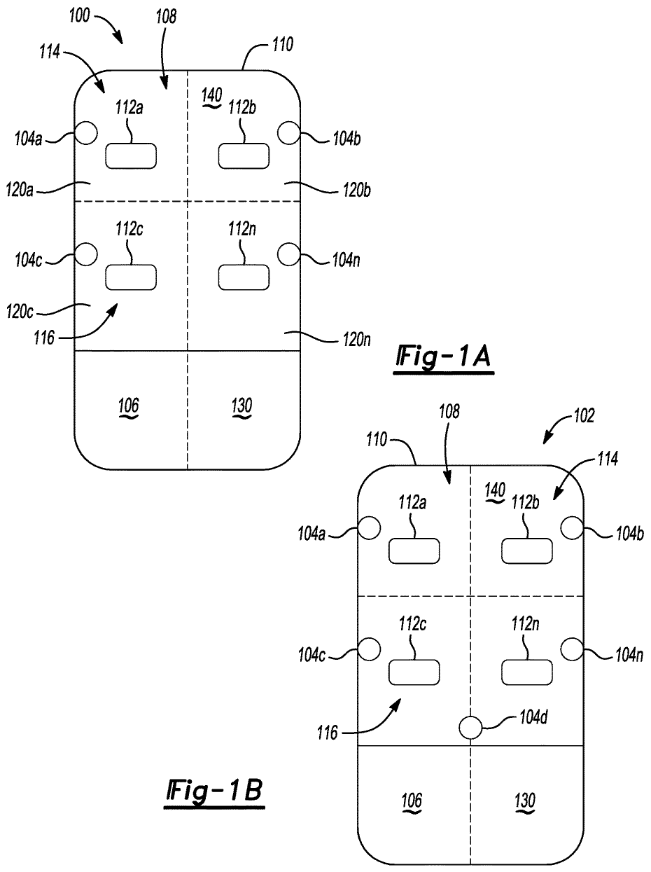

FIGS. 1A-1B generally depict corresponding loudspeaker arrangements 100, 102 (or surround sound loudspeaker arrangement) for surround woofers 104a-104n (“104”) that are employed as part of a surround sound system 106 in a listening environment 108 of a vehicle 110 in accordance to one embodiment. The listening environment 108 includes a plurality of vehicle seats 112 (e.g., a first seat 112a and a second seat 112b) positioned in a first row 114 of the vehicle 110. The listening environment 108 also includes a second row 116 having a third seat 112c and a fourth seat 112n. It is recognized that the number of seats 112 and rows 114, 116 in the vehicle 110 may vary based on the particular implementation of the vehicle 110. The first seat 112a is substantially adjacent to the second seat 112b. The first seat 112a may be a driver seat and the second seat 112b may be a front passenger seat. The third seat 112c may be a left rear passenger seat and the fourth seat 112n may be a right rear passenger seat. The listening environment 108 generally defines various individual sound zones (ISZ) 120a, 120b, 120c, and 120n that includes a corresponding vehicle seat 112a, 112b, 112c, and 112n, respectively. The surround woofers 104 may be generally configured to transmit a lowest frequency audio since the surround woofers 104 may have sufficient size and volume, necessary for a spectral range, starting from, for example f˜20 Hz.

FIG. 1A generally depicts that the zones 120a, 120b, 120c, 120n include the corresponding surround woofer 104a, 104h, 104c, and 104n, respectively. The surround woofers 104a, 104b, 104c, 104n may be combined with midrange and/or tweeter loudspeakers that are generally illustrated at 130 positioned within the listening environment 108 of the vehicle 110 to form the surround sound system 106 to enable vehicle passenger(s) to experience audio playback in the vehicle 110 with a surround sound experience. The surround sound system 106 generally provides an audio output within the listening environment 108 to surround each vehicle occupant by 360 degrees. The surround sound system 106 may utilize three or more audio channels and loudspeakers that are positioned in the front, rear and sides of the vehicle 110 to create a surrounding envelope of sound for the vehicle occupants.

An audio controller 140 is operably coupled to the surround sound system 106 (e.g., the surround woofers 104a, 104h, 104c, and 104n and to the midrange and/or tweeter loudspeakers 130). The audio controller 140 transmits an audio signal to the surround sound system 106 to provide the surround sound effect. The audio controller 140 generally processes information used. in connection with an AM radio, FM radio, satellite radio, navigation system, user interface, display, wireless communication with mobile devices via Bluetooth, WiFi or other wireless protocols, etc. FIG. 1B generally depicts an additional surround woofer 104d that is positioned in the rear of the vehicle 110 (e.g., trunk of the vehicle 110).

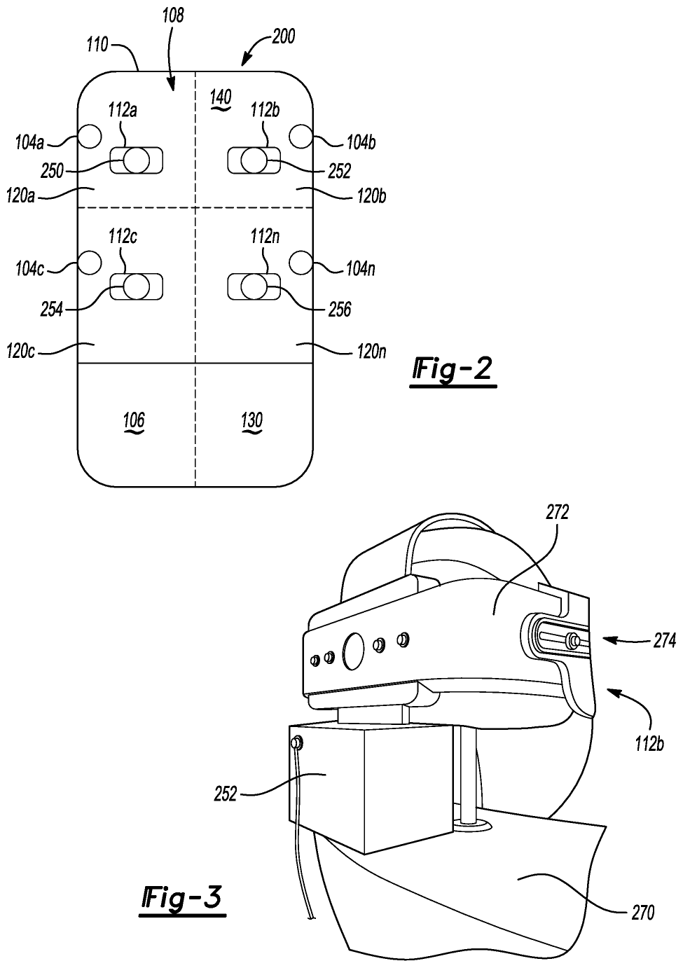

FIG. 2 generally depicts a first loudspeaker arrangement 200 in the vehicle 110 in accordance to one embodiment. The first loudspeaker arrangement 200 generally includes a plurality of proximity woofers 250, 252, 254, and 256 positioned in a corresponding vehicle seat 112a, 112b, 112c, and 112n of the vehicle 110, respectively. The plurality of proximity woofers 250, 252, 254, and 256 are generally configured to also transmit audio in the low frequency range of, for example, 20 Hz to 500 Hz. Each proximity woofer 250, 252, 254, 256 is generally configured to transmit a low frequency audio output in the noted frequency range. It may be advantageous to position the proximity woofers 250, 252, 254, 256 on the vehicle seats 112a, 112b, 112c, 112n as close as possible to the vehicle occupant's heads. In one example, the proximity woofers 250, 252, 254, 256 may be positioned on a headrest or seatback of the vehicle seats 112a, 112b, 112e, 112n.

The proximity woofers 250, 252, 254, 256 on the vehicle seats 112a, 112b, 112c, 112n in combination with the surround woofers 104a, 104b, 104c, and 104n have now been discovered to improve sound separation in the low frequency range between the various zones 120a, 120b, 120c, and 120n of the vehicle 110. For example, by combining surround woofers 104a, 104b, 104c, and 104n with the proximity woofers 250, 252, 254, and 256 being positioned in a respective zone 120a, 120b, 120c, and 120n; such an arrangement has been found to improve low frequency separation performance. In the low frequency ranges (e.g., less than 200 Hz), the listening environment 108 of the vehicle 110 exhibits various acoustical modes that may be formed by standing waves in space. These acoustical modes may be global across the entire listening environment 108 of the vehicle 110. To effectively manipulate (e.g., enhance or attenuate) certain vehicle cabin modes, the surround woofers 104a, 104b, 104c, and 104n are utilized in their respective surround positions in the vehicle 110 and the low frequency output from the audio from such woofers 104a, 104b, 104c, and 104n) coordinate (or coacts) with the low frequency output from the proximity woofers 250, 252, 254, and 256 to provide separate the low frequency output between the corresponding zones 120a, 120b, 120c, and 120n.

FIG. 3 depicts a more detailed view of the second seat 112b and the proximity woofer 252 of FIG. 2 in accordance to one embodiment. In general, the second seat 112b includes a first seatback 270 and a first headrest 272. FIG. 3 depicts that the proximity woofer 252 is positioned in an area between the first seatback 270 and the first headrest 272. As noted above, it may be advantageous to position the proximity woofer 252 as dose as possible to the vehicle occupants. In this ease, the proximity woofer 252 may be positioned anywhere on the second seat 112b (e.g., in the first seatback 270) between the vehicle occupant's ears and/or neck and an upper torso of the vehicle occupant. While not shown in FIG. 3, the proximity woofer 252 may be positioned in the first headrest 272. Conversely, the proximity woofer 252 may be positioned in the first seatback 270. In the embodiment illustrated in FIG. 3, headrest loudspeakers 274 are positioned (or embedded) within the first headrest 272. The headrest loudspeakers 274 may be tweeters or midrange loudspeakers. The headrest loudspeaker 274 may be positioned higher on the second seat 112b relative to the position of the proximity woofer 252.

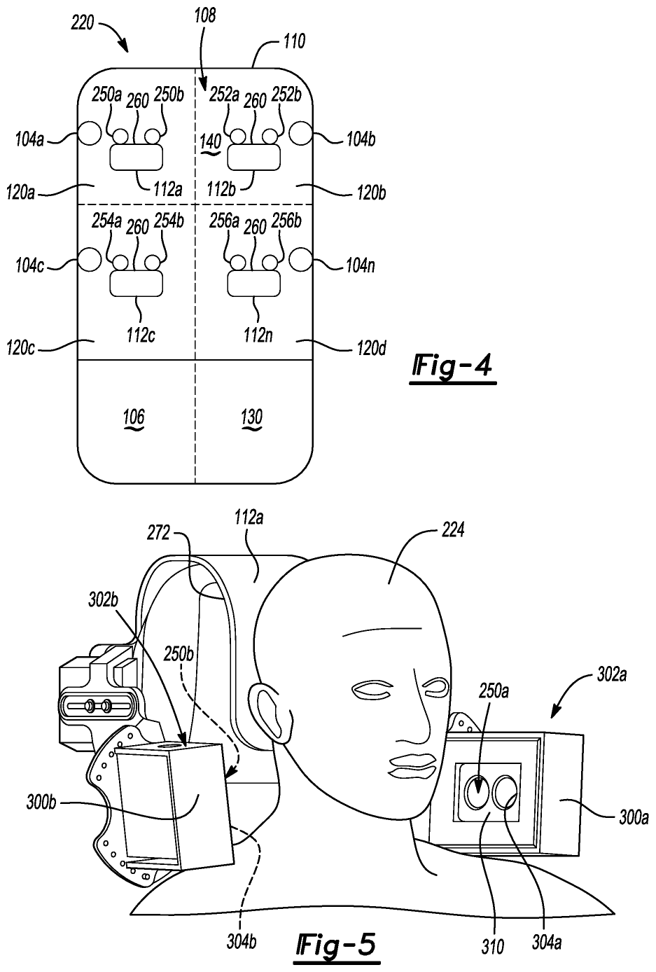

FIG. 4 generally depicts a second loudspeaker arrangement 220 in the vehicle 110 in accordance to one embodiment. As shown, the first seat 112a includes a first plurality of proximity woofers 250a, 250b, the second seat 112b includes a second plurality of proximity woofers 252a, 252b, the third seat 112c includes a third plurality of proximity woofers 254a, 254b and the fourth seat 112n includes a fourth plurality of proximity woofers 256a, 256b. As noted above, the proximity woofers 250a-250b, 252a-252b, 254a-254b, and 256a-256b on the vehicle seats 112a, 112b, 112c, 112n, respectively, in combination with the surround woofers 104a, 104b, 104c, and 104n have now been discovered to improve sound separation in the low frequency range between the various zones 120a, 120b, 120c, and 120n of the vehicle 110. For example, by combining surround woofers 104a, 104b, 104c, and 104n with the proximity woofers 250a-250b, 252a-252b, 254a-254b, and 256a-256b in a respective zone 120a, 120b, 120c, and 120n; such an arrangement has been found to improve low frequency separation performance. Each of the first plurality of proximity woofers 250a, 250b are positioned on a front side 260 of the various seats 112a, 112b, 112c, and 112n (e.g., in front of a headrest or closest to a front side of the vehicle 110) and proximate to a corresponding vehicle occupant.

FIG. 5 depicts a more detailed view of the first seat 112a and the proximity woofers 250a and 250b of FIG. 4 in accordance to one embodiment. In general, the first plurality of proximity woofers 250a and 250b) may be positioned within various loudspeaker housings 300a, 300b that may be integrated into arms 302a, 302b of the first headrest 272. Each housing 300a, 300b may also optionally include a corresponding tweeter and/or midrange loudspeaker 304a, 304b that is packaged with the first plurality of proximity woofers 250a, 250b, respectively. As shown, the arms 302a, 302b are configured to extend forward of a rear portion of the first headrest 272. Thus, the first plurality of proximity woofers 250a and 250b is generally orientated to transmit the low frequency range of the output directly to ears of a vehicle occupant (or listener) 224. The proximity woofers 250a and 250b are arranged on the arms 302a, 302b to face one another. A waveguide 310 may be positioned over the proximity woofer 250a and the loudspeaker 304a to direct the low frequency output and the midrange frequency, respectively, into a particular direction or orientation. It is recognized a corresponding waveguide 310 may be positioned on each housing 300a, 300b. In one example, the proximity woofers 250a and 250b may be orientated on the arms 302a, 302b, at 90 degrees relative to the vehicle occupant's ears. In addition, the proximity woofers 250a and 250b may be orientated on the arms 302a, 302b, facing 90 degrees relative to a vertical plane (e.g., an imaginary vertical plane that extends within the vehicle cabin). In another example, the proximity woofers 250a and 250b may be orientated on the arms 302a, 302b, at a larger angle, such as but not limited to 120 degrees.

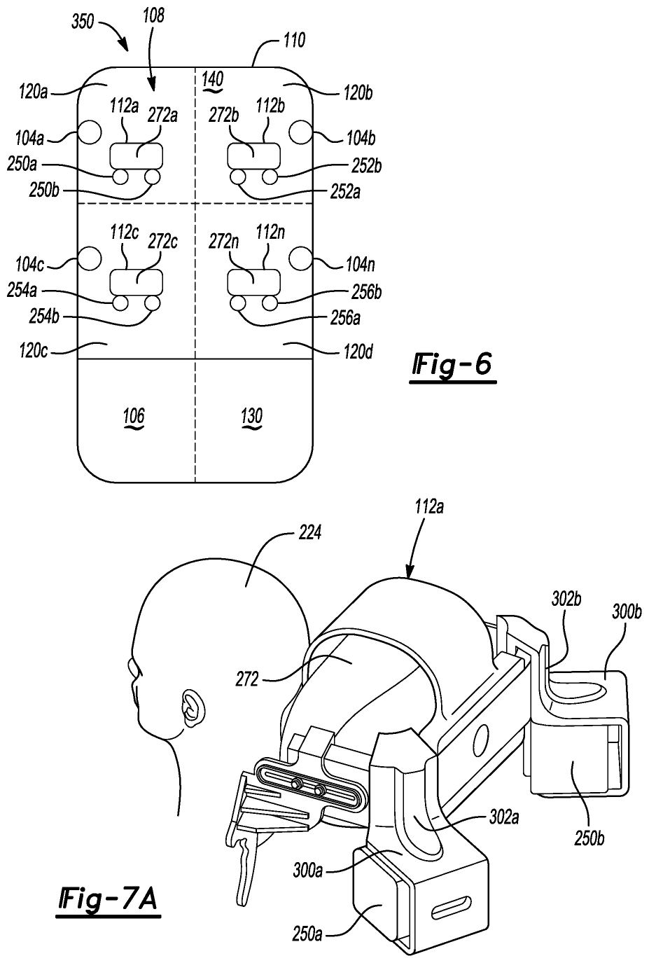

FIG. 6 generally depicts a third loudspeaker arrangement 350 in the vehicle 110 in accordance to one embodiment. The third loudspeaker arrangement 350 is generally similar to the second loudspeaker arrangement 220 as depicted in FIG. 4, however, the proximity woofers 250a-250b, 252a-252b, 254a-254c, and 256a-256h are positioned behind the headrests 272a, 272b, 272c, 272n, respectively, of the vehicle seats 112a, 112b, 112c, 112n. The arrangement of the proximity woofers as illustrated in FIG. 6 may provide passengers more room to move when compared to the implementation in which the proximity woofers are mounted in front of the headrest. Further, this arrangement may also allow the proximity woofers to fire toward each of the passenger's ears similar to the implementation of FIG. 5 without running into the problem of head shadowing, as may be the case if the proximity woofer 250a-250b, 252a-252b, 254a-254c, and 256a-256b are installed in the headrest. In addition, since the proximity woofers 250a-250b, 252a-252b, 254a-254c, and 256a-256b are positioned behind the headrests 272a, 272b, 272c, 272n, respectively, this may enable the use of surround woofers and/or housings, which increases the performance (e.g., the sound pressure level as well as low frequency cut-off of the proximity woofer thereby enabling the proximity woofers 250a-250b, 252a-252b, 254a-254c, and 256a-256b to cover a broader spectral range to be covered). As noted above, the proximity woofers 250a-250b, 252a-252b, 254a-254b, and 256a-256b as positioned on the vehicle seats 112a, 112b, 112c, 112n, respectively, in combination with the surround woofers 104a, 104b, 104c, and 104n that are positioned in the vehicle 110 have now been discovered to improve sound separation in the low frequency range between the various zones 120a, 120b, 120c, and 120n of the vehicle 110. For example, by combining surround woofers 104a, 104b, 104c, and 104n with the proximity woofers 250a-250b, 252a-252b, 254a-254b, and 256a-256b in a respective zone 120a, 120b, 120c, and 120n; such an arrangement has been found to improve low frequency separation performance.

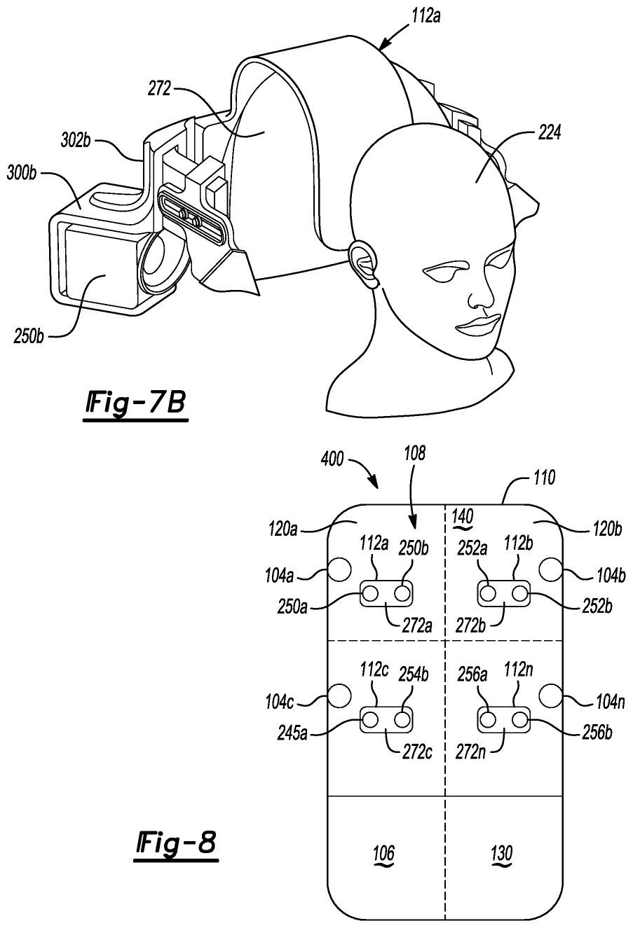

FIGS. 7A-7B depict a first side view and a second side view, respectively, of the proximity woofers 250a, 250b of FIG. 6 in accordance to one embodiment. As noted above in connection with FIG. 6, the proximity woofers 250a, 250b are positioned behind or rearward of the headrest 272. The proximity woofers 250a, 250b are generally orientated to transmit the low frequency output of the audio output towards ears of the listener 224. As shown, the arms 302a, 302b extend rearwardly toward a vehicle occupant 224 who is positioned rearward of the first seat 112a. In one embodiment, each housing 300a, 300b may solely include the proximity woofer 250a, 250b, respectively. Alternatively, each housing 300a, 300b may be equipped with the proximity woofers 250a, 250b in addition to the loudspeakers 304a, 304b as noted above in connection with FIG. 5. It is recognized that the waveguide 310 may also be positioned over the proximity woofers 250a, 250b and/or the loudspeakers 304a, 304b.

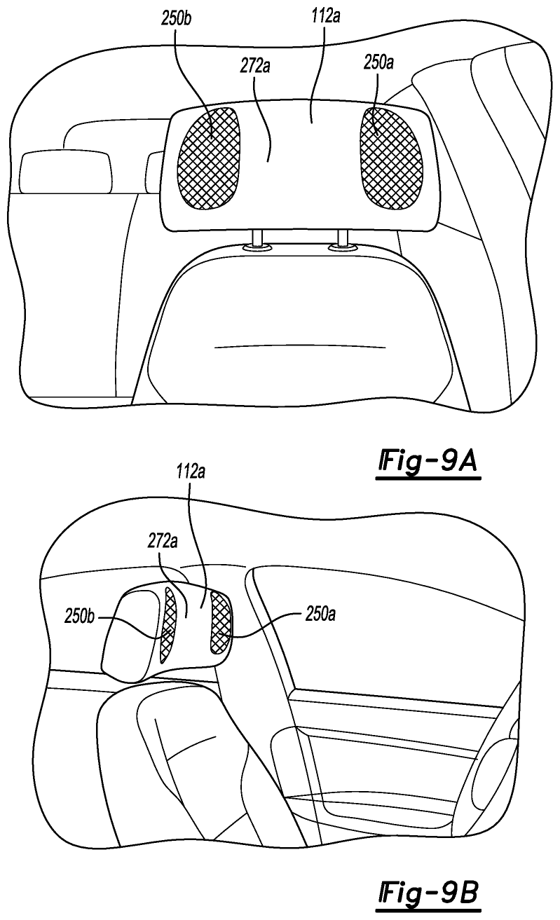

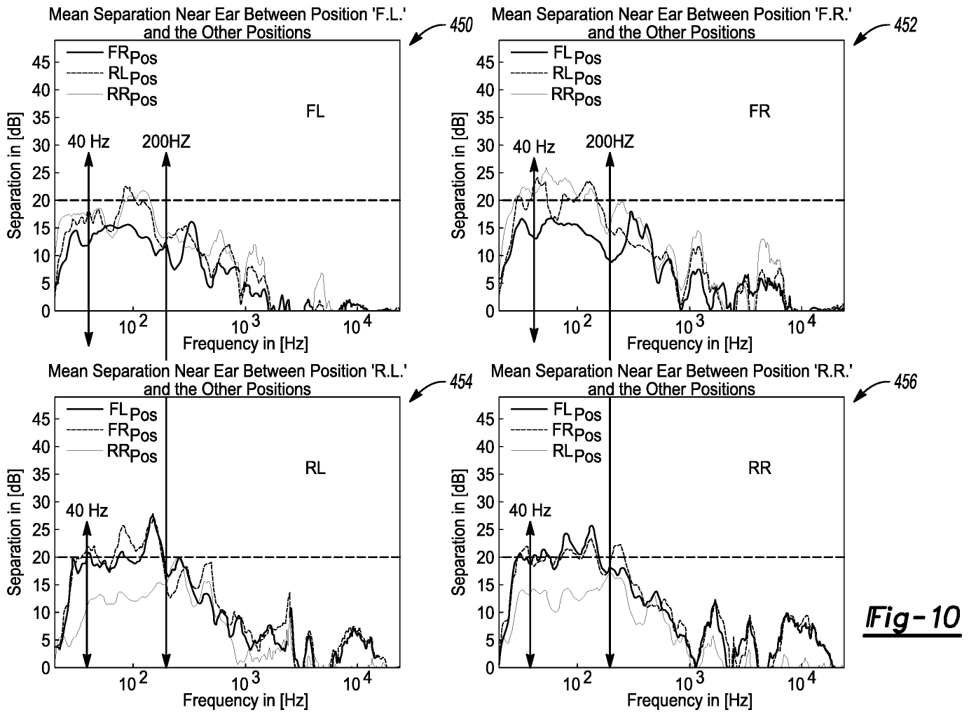

FIG. 8 generally depicts a fourth loudspeaker arrangement 400 in the vehicle 110 in accordance to one embodiment. The fourth loudspeaker arrangement 400 is generally similar to the second loudspeaker arrangement 220 and the third loudspeaker arrangement 350 with the exception being that the proximity woofers 250a-250b, 252a-252b, 254a-254b, and 256a-256b are positioned within the corresponding headrests 272a, 272b, 272c, and 272n, respectively. As noted above, the proximity woofers 250a-250b, 252a-252b, 254a-254b, and 256a-256b on the vehicle seats 112a, 112b, 112c, 112n, respectively, in combination with the surround woofers 104a, 104b, 104e, and 104n have now been discovered to improve sound separation in the low frequency range between the various zones 120a, 120b, 120c, and 120n of the vehicle 110. For example, by combining surround woofers 104a, 104b, 104c, and 104n with the proximity woofers 250a-250b, 252a-252b, 254a-254b, and 256a-256h in a respective zone 120a, 120b, 120c, and 120n; such an arrangement has been found to improve low frequency separation performance.

FIGS. 9A-9B depict a frontal view and a side view, respectively, of the proximity woofers 250a-250b of FIG. 8 in accordance to one embodiment. As shown, the proximity woofers 250a-250b are embedded within the headrest 272a of the seat 112a.

FIG. 10 generally depicts various plots of audio output performance for the surround woofers that are utilized for the surround sound system 106 in the vehicle 110. Plot 450 depicts the audio performance for the surround woofers 104a-104n in case the bright zone is at 120a (e.g., front left zone of the vehicle 110). Specifically, plot 450 depicts a spatial mean separation between the (bright) zone 120a and the remaining (dark) zones 112b-112n of the vehicle 110. The x-axis represents the frequency of the audio output and the y-axis represents the separation in dB between the front left zone and the remaining zones 112b-112n of the vehicle. Plot 450 illustrates that there is a separation between the audio on the front-left zone and the remaining zones 112b-112n of up to 20 dB in the vehicle 110 in a low frequency range (e.g., 40 to 200 Hz).

In general, the plots 450, 452, 454, and 456 illustrate a separation at different positions, if a bright zone is established at one particular seat position. In this case, magnitude spectra as labeled FL (upper left) in plots 450 (e.g., FL), 452 (e.g., FR), 454 (e.g., RL), and 456 (e.g., RR) indicate that the bright zone is at this position, and so on. Further, the magnitude spectra as shaded differently in each plot 450, 452, 454, and 456 also have a connection to the seat positions: FL, FR, RL and RR (the shading of the magna spectra can be matched to the shadings for FL, FR, RL, and RR in the legend (e.g., upper left hand side) for each plot 450, 452, 454, and 456). Hence, the upper left plot illustrates the separation that can be achieved between the various positions e.g., FR, RL, and RR), with respect to the FL position (bright zone).

As also shown, plot 452 depicts the audio performance of the surround woofers 104a-104n to create a bright zone at zone 120b (e.g., front right zone of the vehicle 110), plot 454 depicts the audio performance of the surround woofers 104a-104n to create a bright zone 120c (e.g., rear left zone of the vehicle 110), and plot 456 depicts the audio performance of the surround woofers 104-104n to create a bright zone 120n (e.g., rear right zone of the vehicle 110), while all remaining zones, of each ease, will always be dark zones. Each of these plots 452, 454, and 456 illustrate approximately a similar separation between the corresponding zones and these plots correspond to when only the surround woofers 104a-104n are in the surround sound system 106. This aspect may not provide sufficient ISZ performance, if the target is set, for example, to 20 dB as illustrated in all plots.

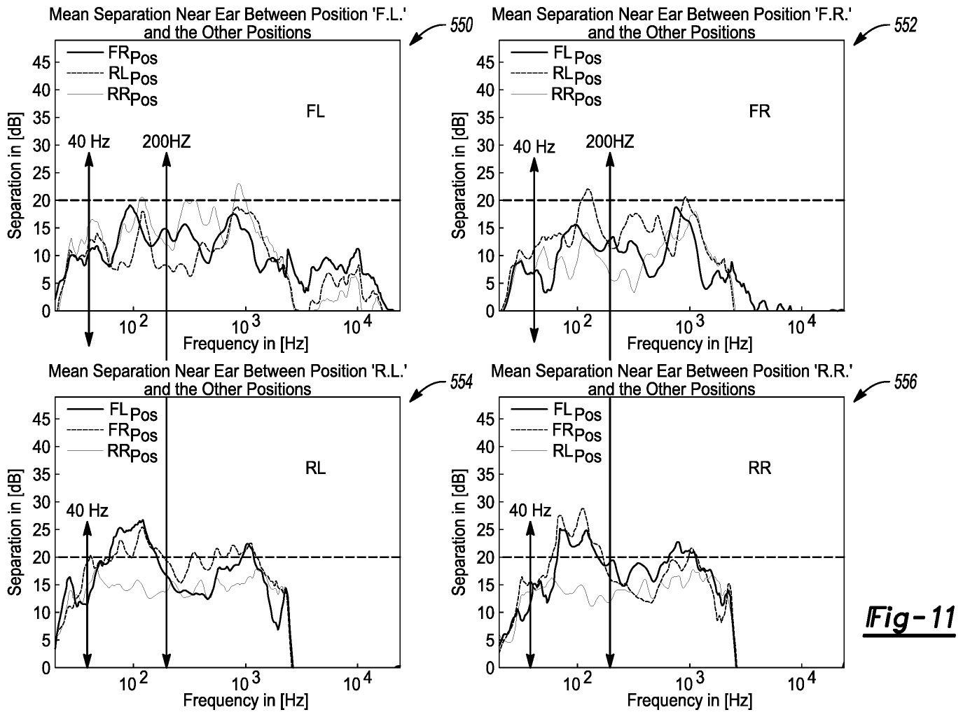

FIG. 11 generally depicts various plots of audio output performance only for the proximity woofers 250, 252, 254, 256 (i.e., without the surround sound system 106) in the vehicle 110. Plot 550 depicts the audio performance if the bright zone is at 120a (e.g., front left zone of the vehicle 110). Specifically, plot 550 depicts a spatial mean separation near or between the zone 120a or the front left zone of the vehicle 110 and other zones 112b-112n of the vehicle 110. Similarly, as noted above, the x-axis represents the frequency of the audio output and the y-axis represents the separation in dB between the front left zone and the remaining zones of the, vehicle 112b-112n of the vehicle 110. Plot 550 illustrates that there is a separation between the audio in the front-left zone and the remaining zones 112b-112n in the vehicle 110 of mostly less than 20 dB in a low frequency range (e.g., 40 to 200 Hz).

As also shown, plot 552 depicts the audio performance if the bright zone is at 120b (e.g., front right zone of the vehicle 110), plot 554 depicts the audio performance if the bright zone is at 120c (e.g., rear left zone of the vehicle 110), and plot 556 depicts the audio performance if the bright zone is at 120n (e.g., rear right zone of the vehicle 110), while again all remaining zones will be dark zones, for all of those cases. Each of these plots 552, 554, and 556 illustrate a comparable separation between the corresponding zones and these plots correspond to when only the proximity woofers 250, 252, 254, and 256 are employed in the vehicle 110. This aspect may not provide sufficient ISZ performance, if the target is set e.g. to 20 dB as illustrated in all plots.

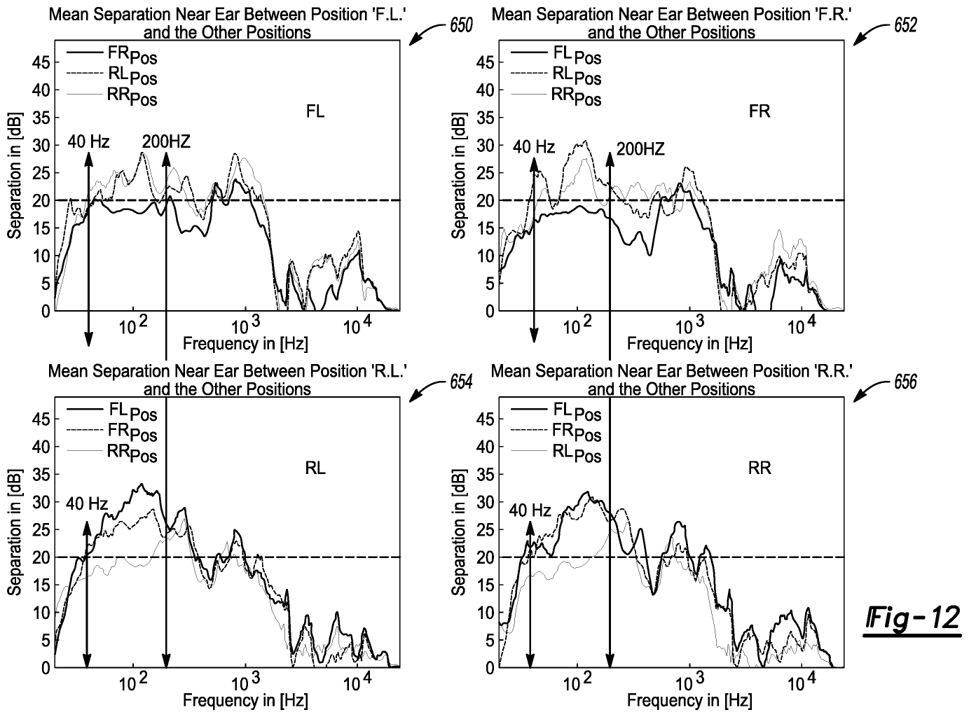

FIG. 12 generally depicts various plots of audio output performance for the surround woofers 104a-104n that are utilized for the surround sound system 106 and for the proximity woofers 250, 252, 254, 256 that are utilized. In connection with the first loudspeaker arrangement 100 in accordance to one embodiment. Plot 650 depicts the audio performance if the bright zone is at 120a (e.g., from left zone of the vehicle 110). Specifically, plot 650 depicts a spatial mean separation near or between the zone 120a or the front left zone of the vehicle 110 and other zones 112b-112n of the vehicle 110, Similarly, as noted above, the x-axis represents the frequency of the audio output and the y-axis represents the separation in dB between the front left zone and the remaining zones of the vehicle 112b-112n of the vehicle 110. Plot 650 illustrates that a desired separation of 20 dB can almost be achieved between the audio in the front-left zone and the remaining zones 112b-112n (only the separation between the FL and the FR position is a bit below this threshold) in the vehicle 110 in the low frequency range (e.g., 40 to 200 Hz).

Plot 650 illustrates that by combining the surround woofers 104a, 104b, 104c, and 104n with the proximity woofers 250, 252, 254, and 256; such an arrangement leads to an improvement over low frequency separation performance. In the low frequency range (e.g., less than 200 Hz), the listening environment 108 of the vehicle 110 exhibits various acoustical modes that may be formed by standing waves in space. These acoustical modes may be global across the entire listening environment 108 of the vehicle 110. To effectively manipulate e.g., enhance or attenuate) certain vehicle cabin modes, the surround woofers 104a, 104b, 104c, and 104n are utilized in their respective surround positions in the vehicle 110 for global modal control and the low frequency output from the audio from the proximity woofers 250, 252, 254, and 256 provide local enhancement to separate the low frequency audio between the corresponding zones 120a, 120b, 120c, and 120n.

As also shown, plot 652 depicts the audio performance if the bright zone is at 120b (e.g., front right zone of the vehicle 110), plot 654 depicts the audio performance if the bright zone is at 120c (e.g., rear left zone of the vehicle 110), and plot 656 depicts the audio performance if the bright zone is at 120n (e.g., rear right zone of the vehicle 110), in each of those cased, all remaining zones are established as dark zones. Each of these plots 652, 654, and 656 illustrate an improvement in separation between the corresponding zones. In general, the surround woofers may only be able to create standing waves or room modes, within the interior of the vehicle 110 (i.e., the surround woofers can create a global wave field which may be beneficial for the separation between individual positions and may be limited to generate enough contrast between individual positions) while proximity woofers may be able to control. the wave field locally, i.e., individually at each. position, and ear position of each zone. By utilizing the surround woofers that control room modes and a global wave field in combination of the proximity woofers that control the wave field of the audio locally al each zone, position, or ear position, etc., these attributes provide a low frequency separation between the respective zones 120a-120n of the vehicle 110.

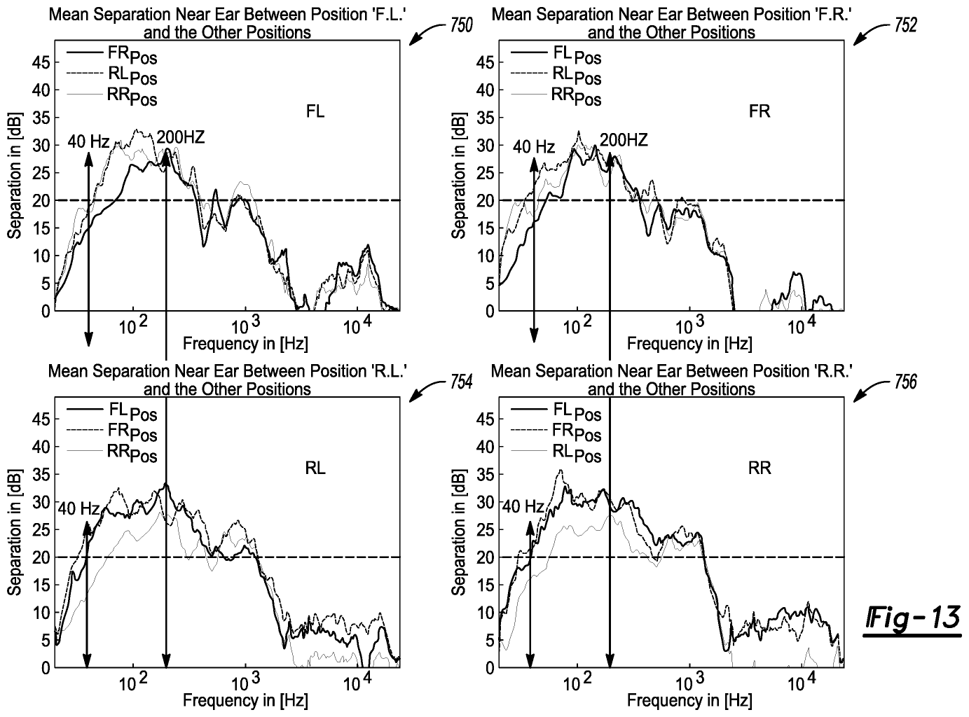

FIG. 13 generally depicts various plots of audio output performance for the surround woofers 104a-104n that are utilized for the surround sound system 106 and for the proximity woofers 250, 252, 254, 256 that are utilized in connection with the third loudspeaker arrangement 350 in accordance to one embodiment. Plot 750 depicts the audio performance for the surround woofer and the proximity woofers in the zone 120a (e.g., front left zone of the vehicle 110). Specifically, plot 750 depicts a mean separation near or between the zone 120a or the front left zone of the vehicle 110 and other zones 112b-112n of the vehicle 110. Similarly, as noted above, the x-axis represents the frequency of the audio output and the y-axis represents the separation in dB between the front left zone and the remaining zones of the vehicle 112b-112n of the vehicle 110. Plot 750 illustrates that an improvement in audio separation between the audio on the front-left zone and the remaining zones 112b-112n in the vehicle 110 may be realized due to the low frequency range of the audio output surpassing 20 dB in a low frequency range (e.g., 40 to 200 Hz). Thus, the third loudspeaker arrangement 350 with the utilization of a plurality of proximity woofers in a corresponding zone along with the surround woofers further improve the low frequency separation performance.

As also shown, plot 752 depicts the audio performance if the bright zone is at 120b (e.g., front right zone of the vehicle 110), plot 754 depicts the audio performance if the bright zone is at 120c (e.g., rear left zone of the vehicle 110), and plot 756 depicts the audio performance if the bright zone is at 120n (e.g., rear right zone of the vehicle 110), While for each of those eases all remaining zones are established as dark zones. Each of these plots 752, 754, and 756 illustrate an improvement in separation between the corresponding zones.

While it has been noted that the proximity woofers in combination with the surround woofers improve low frequency separation performance, it is recognized that such a combination also yields improvements to individual engine order cancellation (FOC) or road noise cancellation (RNC) (i.e., generally to active noise cancellation (ANC)), independent surround zone, bass enhancement/management, engine sound synthesis (ESS), etc. First of all, all of these aspects may benefit from the proximity of those proximity woofers (even their smaller footprint (or dimension)) since, due to their proximity, and despite their small size, the proximity woofers are able to generate high SPL at the passenger's ears, which may be needed for ANC, bass enhancement/management, and ESS.

Second, particularly for ANC applications, due to the low latency and dose proximity of proximity woofers to the ears of the passengers is beneficial, since this relaxes, the otherwise limiting latency of the overall signal flow (from a reference sensor (e.g. microphone, accelerometer, RPM-sensor, etc.) via an optional A/D-converter, an ANC-filter, a D/A-converter, the loudspeaker (as represented by the proximity woofer), via the secondary path to the error microphone). Due to this lower, overall latency and high SPL (e.g., >=90-100 dBSPL) at the passenger's ears attributed to the proximity woofers, even at low frequencies, the proximity woofers may be well suited for ANC applications, in particular within car environments, as, due to those positive aspects, it is possible to expect not just an improvement in the ANC performance (higher noise reduction), but also an enlargement of the spectral range of operation, in which such an ANC performance can be achieved (e.g., the broadening of the useful spectral range).

Due to the lateral arrangement of the proximity woofers as positioned on the respective seats, it is possible to enhance an individual surround in a corresponding sound zone. The lateral arrangement of the proximity woofers generally corresponds to such speakers being mounted to directly face a passenger's ears (e.g., a corresponding proximity woofer faces a right ear and a corresponding proximity woofer faces a left ear). This aspect may enable binaural cues, which are especially useful to create a pleasant surround sound effect which may not be accomplished if the speakers are directly mounted into the headset and faces the back of the passenger's head. It is recognized that the proximity woofers may not have to be directly oriented to provide audio directly to the passenger's ears (e.g., be mounted with a 90 degrees angle to the ears), but that the proximity woofers can be orientated at a larger angle (e.g., 120 degrees). It is also recognized that the proximity woofers may be positioned in, for example, a corresponding zone that is defined by: (i) +/−40 cm in relation to an overall width of the backrest of the vehicle seat, (ii) 8 cm below a vehicle occupant's ear while the vehicle occupant is normally positioned on the vehicle seat, and/or (iii) 8-17 cm in front of a headrest (or to a rear of the headrest) of the vehicle seat. Thus, the proximity woofers as disclosed in connection with FIGS. 3, 5, 7A-7B, and 9A-9B may be positioned in the zone that is noted directly above to establish a location for the positioning of the proximity woofers in the vehicle.

In connection with bass management and individual ANC/RNC/EOC (or individual zones in relation to ANC/RNC/EOC), the combination of the surround woofers and the proximity woofers are also beneficial for the following reasons below. For example, often, proximity woofers may be, despite their close proximity to the listeners, especially at low frequencies (e.g., approximately f<50 Hz) too weak (i.e., the proximity woofers provide at a low frequency, a low SPL) in comparison to low frequency output provided by surround woofers. In general, at these low frequencies, the sound pressure chamber effect of the cabin of the vehicle (or the listening environment of the vehicle) is already present, leading to an amplification of the sound pressure. This may not be achieved by proximity woofer alone, since proximity woofers may not be strong enough to stimulate/erect a complete sound field within the interior of the vehicle. The surround woofers may be strong enough to do this since the surround woofers are generally large and are mounted to components in the vehicle that have more volume than that of space or volume that the proximity woofers are enclosed within. Hence, the combination of, the proximity and surround woofers lead to an amplification of sound pressure which may also enlarge the useful spectral range also to very low frequencies.

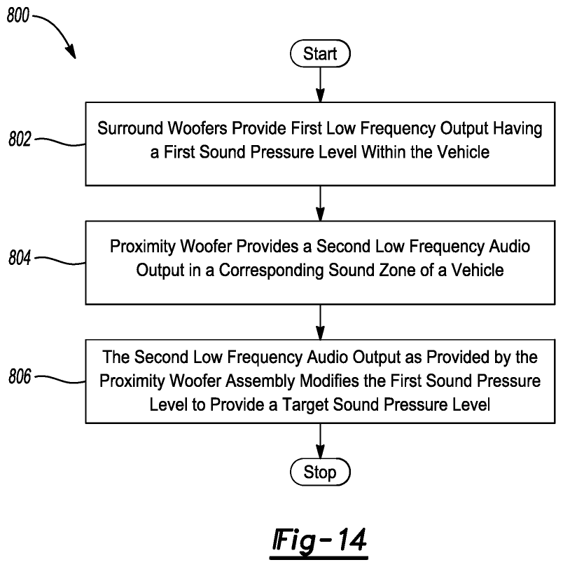

FIG. 14 generally depicts a method 800 for adjusting a sound pressure level of a low frequency output from surround woofers in accordance to one embodiment, it is recognized that the operations performed in the method 800 may he applied applicable for ISZ, ANC, bass management, and individual surround zone applications.

In operation 802, the audio controller 140 transmits an audio signal to the surround sound system 106 for audio playback in the listening environment 108. The surround woofers 104 provide a first low frequency audio output having a first sound pressure level for the audio signal in the, vehicle 110.

In operation 804, the audio controller 140 transmits the audio signal to each proximity woofer 250, 252, 254, 256 in a corresponding zone. Each of the proximity woofers 250, 252, 254, 256 provides a second low frequency audio output in a corresponding zone 120.

In operation 806, the second low frequency audio output as provided by proximity woofers 250, 252, 254, 256 modifies the first sound pressure level to provide a target sound pressure level. The target sound pressure level may generally correspond to a final effective sound pressure level (e.g., 0 or 120 dBSPL) of an audio signal that is received by a listener. In one example, the final effective sound pressure for ISZ and/or ANC applications may be 0 dBSPL. The other values that fall within the final effective sound pressure level (e.g., 0 to 120 dBSPL) may be applicable for audio and bass management applications. The second low frequency audio output as provided by the proximity woofers 250, 252, 254, 256 may increase the first sound pressure level associated with the output from the surround sound system 106 and the corresponding surround woofers 104 to provide the final effective sound pressure. The surround woofers can provide enough power (or enough of the sound pressure level) however, the surround woofer may not be able to individually control an acoustical sound field. The inclusion of the proximity woofers provides a local solution in controlling the acoustical sound field.

In order to enable manipulation of the effective sound pressure of the low frequency audio output provided by the surround woofers 104, the received sound pressure level of low frequency audio output of the proximity woofer 250, 252, 254, 256 should be at least equal, or greater than the sound pressure of the low frequency audio output in the corresponding sound zone 112a-112n. By manipulating control of the first sound pressure level, this aspect may benefit the ISZ, ANC, bass management, individual surround sound zone, and ESS applications in the vehicle 110. In general, the modification of the first sound pressure level associated with the output from the surround sound system 106 generally provides greater control over the sound pressure for each corresponding sound zone 112a-112n for ISZ, ANC, individual surround sound in the zones, and ESS applications. Bass management may also be improved overall in the listening environment due the cumulative effect of modifying the sound pressure individually at each zone which in turn bolsters the performance of the effect of the bass overall for the entire listening environment 108.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A loudspeaker arrangement for a vehicle comprising:
a surround sound loudspeaker arrangement including a plurality of surround woofers being positioned in a listening environment in the vehicle that defines a plurality of sounds zones to provide a first low frequency audio output having a first sound pressure level within the vehicle; and
at least one proximity woofer positioned about a first seat in a first sound zone of the vehicle, the at least one proximity woofer being configured to provide a second low frequency audio output in the first sound zone of the vehicle,
wherein the second low frequency audio output as provided by the at least one proximity woofer modifies the first sound pressure level to provide a target sound pressure level; and
wherein the target sound pressure level corresponds to a final effective sound pressure level of an audio signal that is received by a listener.

2. The loudspeaker arrangement of claim 1, wherein a received sound pressure level of the second low frequency audio output provided by the proximity woofer exceeds the first sound pressure level associated with the first low frequency audio output at a sound zone in which the proximity woofer is positioned in prior to the at least one proximity woofer modifying the first sound pressure.

3. The loudspeaker arrangement of claim 1, wherein the first low frequency audio output and the second low frequency audio output provide a separation between the first sound zone and remaining sound zones in the vehicle.

4. The loudspeaker arrangement of claim 1, wherein the surround sound loudspeaker arrangement and the at least one proximity woofer are used in at least one or more of an active noise cancellation system, a bass management system, an engine order cancellation (EOC)/road noise cancellation (RNC) system, and an individual surround sound system for the vehicle.

5. The loudspeaker arrangement of claim 1, wherein one or more of the plurality of surround woofers are positioned in at least one of a vehicle door, a rear interior portion of the vehicle, or in a trunk of the vehicle.

6. The loudspeaker arrangement of claim 1, wherein the at least one proximity woofer is positioned between a headrest and a seatback of the first seat.

7. The loudspeaker arrangement of claim 1, wherein the at least one proximity woofer includes a first proximity woofer that is positioned on a first arm that extends from a headrest of the first seat.

8. The loudspeaker arrangement of claim 7, wherein the at least one proximity woofer includes a second proximity woofer positioned on a second arm that extends from the headrest of the first seat.

9. The loudspeaker arrangement of claim 8, wherein the first arm and the second arm extend forward toward a front of the vehicle from the headrest.

10. The loudspeaker arrangement of claim 1, wherein the first low frequency audio output and the second low frequency audio output correspond to a frequency that is within a range of 40 to 500 Hz.

11. The loudspeaker arrangement of claim I , wherein the final effective sound pressure level is a value within 0 to 120 dB.

12. A loudspeaker arrangement for a vehicle comprising:
a plurality of surround woofers for a surround sound system being positioned in a listening environment of the vehicle that defines a plurality of sounds zones to provide a first low frequency audio output having a first sound pressure level in the plurality of sound zones; and
at least one proximity woofer positioned about a first seat in a first sound zone of the vehicle, the at least one proximity woofer being configured to provide a second low frequency audio output in the first sound zone of the vehicle,
wherein the second low frequency audio output as provided by the at least one proximity woofer modifies the first sound pressure level to provide a target sound pressure level; and
wherein the target sound pressure level corresponds to a final effective sound pressure level of an audio signal that is received by a listener.

13. The loudspeaker arrangement of claim 12, wherein a received sound pressure level of the second low frequency audio output provided by the proximity woofer exceeds the first sound pressure level associated with the first low frequency audio output at a sound zone in which the proximity woofer is positioned in prior to the at least one proximity woofer modifying the first sound pressure.

14. The loudspeaker arrangement of claim 12, wherein the first low frequency audio output and the second low frequency audio output provide a separation between the first sound zone and remaining sound zones in the vehicle.

15. The loudspeaker arrangement of claim 12, wherein the plurality of surround woofers and the at least one proximity woofer are used in at least one or more of an active noise cancellation system, a bass management system, an engine order cancellation (EOC)/road noise cancellation (RNC) system, and an individual surround sound system for the vehicle.

16. The loudspeaker arrangement of claim 12, wherein the first low frequency audio output and the second low frequency audio output corresponds to a frequency that is within a range of 40 to 500 Hz.

17. The loudspeaker arrangement of claim 12, wherein one or more of the plurality of surround woofers are positioned in at least one of a vehicle door, a rear interior portion of the vehicle, or in a trunk of the vehicle.

18. The loudspeaker arrangement of claim 12, wherein the final effective sound pressure level is a value within 0 to 120 dB.

19. A loudspeaker arrangement for a vehicle comprising:
a surround sound loudspeaker arrangement including a plurality of surround woofers being positioned in a listening environment in the vehicle that defines a plurality of sounds zones to provide a first low frequency audio output having a first sound pressure level within the vehicle; and
at least one proximity woofer positioned about a first seat in a first sound zone of the vehicle, the at least one proximity woofer being configured to provide a second low frequency audio output in the first sound zone of the vehicle,
wherein the second low frequency audio output as provided by the at least one proximity woofer modifies the first sound pressure level to provide a target sound pressure level;
wherein the target sound pressure level corresponds to a final effective sound pressure level of an audio signal that is received by a listener; and
wherein the plurality of surround woofers and the at least one proximity woofer are used in at least one or more of an active noise cancellation system, a bass management system, an engine order cancellation (EOC)/road noise cancellation (RNC) system, an individual surround sound system, and individual sound zones (ISZ) for the vehicle.

20. The loudspeaker arrangement of claim 19, wherein a received sound pressure level of the second low frequency audio output provided by the proximity woofer exceeds the first sound pressure level associated with the first low frequency audio output at a sound zone in which the proximity woofer is positioned in prior to the at least one proximity woofer modifying the first sound pressure.
